(19) United States
(12) Patent Application Publication
(10) Pub. No.: US 2007/0169849 A1
(43) Pub. Date: Jul. 26, 2007

(54) APPARATUS AND METHOD

(76) Inventors: Susumu Yahagi, Yokohama-shi (JP); Atsushi Ooe, Fujisawa-shi (JP); Masakazu Hayashi, Ebina-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/624,414

(22) Filed: Jan. 18, 2007

(30) Foreign Application Priority Data
Jan. 20, 2006 (JP) 2006-012349

(51) Int. Cl. B27L 5/00; B27L 7/00; B27M 1/00

(52) U.S. Cl. 144/366; 144/364; 144/380

(57) ABSTRACT

An apparatus comprises a holding mechanism for holding an object and a processing mechanism for irradiating the object held by the holding mechanism with a laser beam to locally heat/cool the object. The holding mechanism curves the object so as to project an expected splitting line of the object.

### CROSS-REFERENCE TO RELATED APPLICATIONS

This application is based upon and claims the benefit of priority from prior Japanese Patent Application No. 2006-012349, filed Jan. 20, 2006, the entire contents of which are incorporated herein by reference.

### BACKGROUND OF THE INVENTION

1. Field of the Invention
This invention relates to an apparatus for splitting fragile materials such as glass and ceramics and also to a method of splitting fragile materials such as glass and ceramics.

2. Description of the Related Art

A technique as described below has been proposed to break an object that is made of a fragile material such as a glass substrate of a liquid crystal display panel or a plasma display panel. With this technique, the object is locally heated and cooled to develop the initial fissure made in the object in advance and break the object by the thermal stress (tensile stress) which is produced at then.

More specifically, with such a splitting method, the object is applied with a laser beam to become locally heated. Then, the initial fissure made in the object of treatment is developed by moving the region of irradiation of the laser beam in the object along an expected splitting line.

When splitting an object in a manner as described above, the processing is required to be highly accurate. For this reason, improved object holding mechanisms for holding an object have been proposed to stably develop the fissure made in the object.

More specifically, fixing jigs which provide the object with rigidity are fitted to the opposite sides of the object with the expected splitting line interposed between them. The fixing jigs equalize the rigidity of the object at opposite sides relative to the expected splitting line. For instance, Jpn. Pat. Appln. Laid-Open Publication No. 2002-110589 discloses such a fixing jig.

On the other hand, the internal stress produced in the inside of the object significantly influences the development of the fissure in the object.

With a splitting method using fixing jigs as disclosed in Jpn. Pat. Appln. Laid-Open Publication No. 2002-110589, the development of the fissure of an object may not proceed along the expected splitting line due to the influence of the internal stress.

### BRIEF SUMMARY OF THE INVENTION

An apparatus according to the present invention comprises a holding mechanism for holding an object and a processing mechanism for applying a laser beam to the object held by the holding mechanism, to locally heat the object. The holding mechanism curves the object to project the expected splitting line of the object.

In a preferable embodiment of the invention, the holding mechanism includes a plurality of support sections arranged substantially in parallel with each other substantially at regular intervals. The holding mechanism adjusts the height of the support sections and holds the object so as to project the expected splitting line.

Preferably, the holding mechanism includes a gas float mechanism. The gas float mechanism has an opposite surface to be arranged opposite to the object and holds the object in a floating state with respect to the opposite surface by spouting gas toward the object. The spouting pressure of the gas in the vicinity of the expected splitting line of the object is higher than the spouting pressure at sites other than in the vicinity of the expected splitting line of the object so as to project the expected splitting line most.

In a preferable embodiment of the invention, the holding mechanism includes a gas float mechanism. The gas float mechanism has an opposite surface to be arranged opposite to the object and holds the object in a floating state with respect to the opposite surface by spouting gas toward the object. The gas float mechanism has a containing section for containing gas before being spouted. A plurality of spouting holes to be passed by gas contained in the containing section are formed through the opposite surface. The opposite surface is curved to project at the site thereof located opposite to the expected splitting line.

Preferably, the opposite surface has a first region located and a second region. The first region is opposite to the corner sections of the object. The spouting holes formed in the first region are larger than the spouting holes formed in the second region.

Alternatively, the opposite surface has a first region and a second region. The first region is located opposite to a corner section of the object. The spouting holes are formed more densely in the first region than in the second region.

In a preferable embodiment of the invention, the holding mechanism includes an gas float mechanism. The gas float mechanism has an opposite surface to be arranged opposite to the object and holds the object in a floating state with respect to the opposite surface by spouting gas toward the object. The gas float mechanism has a plurality of containing sections which extend along the expected splitting line. The containing sections are arranged in a direction intersecting the expected splitting line. The containing sections contain gas before being spouted. A plurality of spouting holes to be passed by gas contained in the containing sections are formed through the opposite surface. Passage sections which leads gas into the respective containing sections are provided with respective valves for adjusting the gas spouting pressure.

In a preferable embodiment of the invention, the holding mechanism includes a guide section for supporting the object by pinching the object from the opposite sides thereof with the expected splitting line interposed between them. The guide section is deformed to absorb the displacement of the object.

In a method according to the present invention an object is deformed so as to cause a tensile stress thereof to act on the opposite sides of the object with respect to the expected splitting line of the object operating as center line. More specifically, there is provided a method of splitting an object by locally heating and cooling the object and making a fissure in the object by the thermal stress thereof, the method comprising deforming the object so as to cause the tensile stress thereof to act on the opposite sides of the object with respect to the expected splitting line of the object operating as center line.

In a preferable embodiment of the method according to the invention, the object is deformed by means of a holding mechanism for holding the object. The holding mechanism includes support sections which are arranged at least one at each of the opposite sides with the expected splitting line interposed between them, extend along the expected splitting line and adapted to contact the opposite surface of the object to be located opposite to the holding mechanism so as to project the expected splitting line.

Preferably, a plurality of support sections are formed. The holding mechanism has a height adjusting mechanism for adjusting the heights of the plurality of support sections.

In a preferable embodiment of method according to the invention, an object is held in a floating state by gas spouted from a plurality of gas spouting holes. The spouting pressure of gas in the vicinity of the expected splitting line of the object is made higher than the spouting pressure at sites other than in the vicinity of the expected splitting line of the object so as to project the expected splitting line most.

In a preferable embodiment of splitting method according to the present invention, the object is deformed by means of the holding mechanism for holding the object. The holding mechanism includes an gas float mechanism. The gas float mechanism has an opposite surface to be arranged opposite to the object and holds the object in a floating state with respect to the opposite surface by spouting gas toward the object. The gas float mechanism has a containing section for containing gas before being spouted. A plurality of spouting holes to be passed by gas contained in the containing section are formed through the opposite surface. The opposite surface is curved so as to project at the site thereof located opposite to the expected splitting line.

Preferably, the opposite surface has a first region and a second region. The first region is located opposite to the corner sections of the object and. The spouting holes formed in the first region are larger than the spouting holes formed in the second region.

Alternatively, the opposite surface has a first region located and a second region. The first region is opposite to the corner sections of the object. The Spouting holes are formed more densely in the first region than in the second region.

In a preferable embodiment of splitting method according to the invention, the object is deformed by means of the holding mechanism for holding the object. The holding mechanism includes an gas float mechanism. The gas float mechanism has an opposite surface to be arranged opposite to the object and holds the object in a floating state with respect to the opposite surface by spouting gas toward the object. The gas float mechanism has a plurality of containing sections which extend along the expected splitting line. The containing sections are arranged in a direction intersecting the expected splitting line. The containing sections contain gas before being spouted. A plurality of spouting holes to be passed by gas contained in the containing sections are formed through the opposite surface. Passage sections for leading gas into the respective containing sections are provided with respective valves for adjusting the gas spouting pressure.

In a preferable embodiment of splitting method according to the invention, the object is deformed by means of the holding mechanism. The holding mechanism includes a guide section for supporting the object by pinching the object from the opposite sides thereof with the expected splitting line interposed between them. The guide section is deformed to absorb the displacement of the object.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic illustration of an apparatus according to a first embodiment of the invention;

FIG. 2 is a schematic plan view of the apparatus of FIG. 1;

FIG. 3 is a schematic lateral view of the apparatus as viewed in the direction of F3 shown in FIG. 1;

FIG. 4 is a schematic lateral view of the area indicated by F4 shown in FIG. 3;

FIG. 5 is a schematic plan view of the object of FIG. 1 that is being broken;

FIG. 6 is a schematic cross sectional view taken along line F6-F6 shown in FIG. 5;

FIG. 7 is a schematic cross sectional view taken along line F7-F7 shown in FIG. 5;

FIG. 8 is a schematic perspective view of an apparatus according to a second embodiment of the invention;

FIG. 9 is a schematic lateral view of the second embodiment of apparatus as viewed in the direction along which the first through sixth support members of FIG. 8 extend;

FIG. 10 is an exploded schematic perspective view of the air float apparatus shown in FIG. 8;

FIG. 11 is a schematic plan view of an apparatus according to a third embodiment of the invention;

FIG. 12 is a schematic perspective view of an air float apparatus of an apparatus according to a fourth embodiment of the invention;

FIG. 13 is an exploded schematic perspective view of the air float apparatus shown in FIG. 12;

FIG. 14 is a schematic lateral view of the apparatus shown in FIG. 12 as viewed in the direction along which the first through sixth support members of FIG. 12 extend;

FIG. 15 is a schematic perspective view of a holding mechanism of an apparatus according to a fifth embodiment of the invention;

FIG. 16 is a schematic plan view of the air float apparatus shown in FIG. 15;

FIG. 17 is a schematic cross sectional view taken along line F17-F17 shown in FIG. 15;

FIG. 18 is a schematic perspective view of an air float apparatus of an apparatus according to a sixth embodiment of the invention; and

FIG. 19 is a schematic plan view of the air float apparatus shown in FIG. 18.

### DETAILED DESCRIPTION OF THE INVENTION

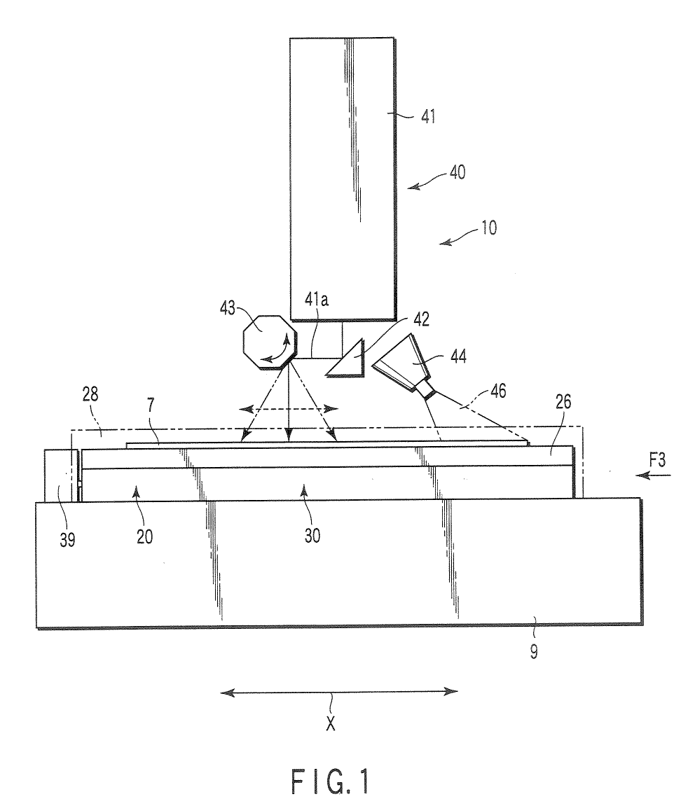

Now, an apparatus according to the first embodiment of the invention will be described below by referring to FIGS. 1 through 7. FIG. 1 is a schematic illustration of the apparatus 10 as viewed from a lateral side of the apparatus 10. The apparatus 10 breaks an object 7 by producing a fissure in the object 7 that is made of a fragile material.

The expression of fragile material as used herein for example refers to glass or ceramic. Note that the object 7 as described below for the first embodiment is for example a glass substrate.

As shown in FIG. 1, the apparatus 10 comprises a holding mechanism 20 for holding an object 7, an XY stage 9 on which the holding mechanism 20 is mounted and which is movable in X-Y direction and a processing mechanism 40 for splitting the object 7 by heating/cooling the object 7.

The holding mechanism 20 is set on the XY stage 9. The holding mechanism 20 can be moved in the X-Y direction by means of the XY stage 9. Note that the direction X is the transversal direction (left and right direction) of FIG. 1, whereas the direction Y is the direction perpendicular to FIG. 1. The holding mechanism 20 holds the object 7.

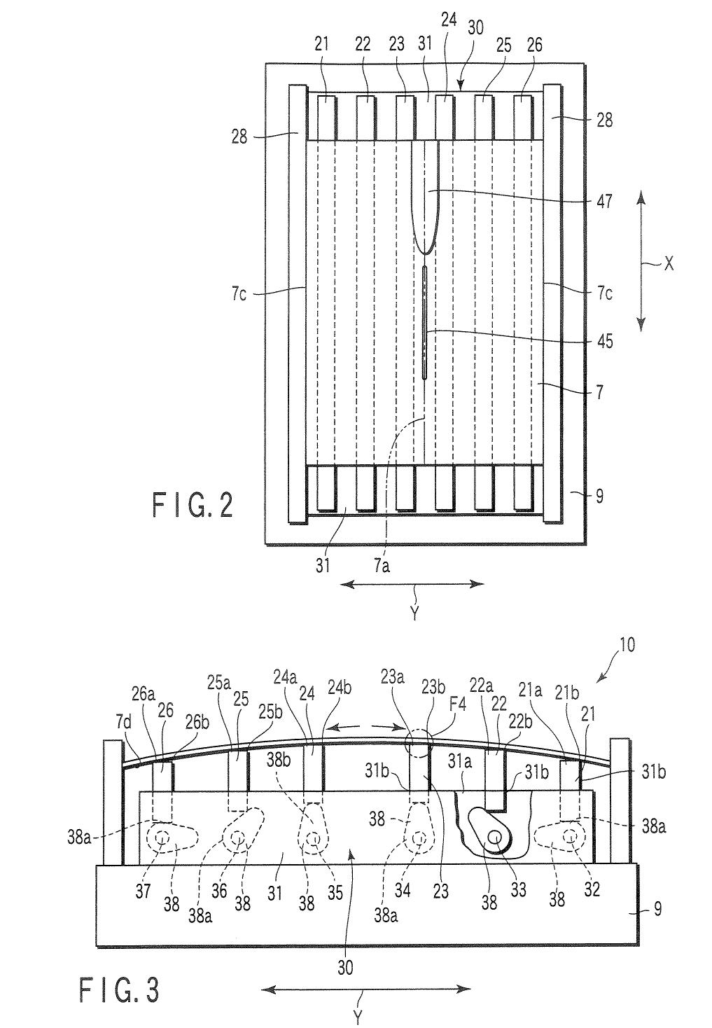

The holding mechanism 20 includes first through sixth support members 21 through 26, a height adjusting mechanism 30 and a pair of guide members 28. FIG. 2 is a plan view of the apparatus 10 as viewed from above. Note that the processing mechanism 40 is omitted from FIG. 2. As shown in FIGS. 1 and 2, the object 7 for example has a plate-shaped profile showing a substantially rectangular contour as viewed from above.

The first through sixth support members 21 through 26 are contained in a cabinet 31 of the height adjusting mechanism 30, which will be described in greater detail hereinafter. As seen from FIG. 2, the first through sixth support members 21 through 26 respectively have substantially linear profiles that are almost identical with each other. The first through sixth support members 21 through 26 are arranged in such a way that they are separated from each other and, at the same time, running substantially in parallel with each other.

FIG. 3 is a schematic lateral view of the apparatus 10 as viewed in the direction of F3 shown in FIG. 1. As shown in FIG. 3, the height adjusting mechanism 30 includes a cabinet 31, first through sixth drive shafts 32 through 37, a plurality of cams 38 and a drive section 39 (shown in FIG. 1).

The cabinet 31 is mounted on the XY stage 9. The cabinet 31 is provided at the upper wall 31a thereof with through holes 31b so that the cabinet 31 can vertically movably contain the support members 21 through 26. The first through sixth support members 21 through 26 are partly contained in the cabinet 31 by way of the respective through holes 31b.

The first through sixth support members 21 through 26 are arranged from the right in FIG. 3 in the proper order. The first through sixth support members 21 through 26 show a rectangular cross section.

The first through sixth drive shafts 32 through 37 are also contained in the cabinet 31. The first drive shaft 32 is arranged below the first support member 21. The first drive shaft 32 extends in parallel with the first support member 21. The second drive shaft 33 is arranged below the second support member 22. The second drive shaft 33 extends in parallel with the second support member 22.

The third drive shaft 34 is arranged below the third support member 23. The third drive shaft 34 extends in parallel with the third support member 23. The fourth drive shaft 35 is arranged below the fourth support member 24. The fourth drive shaft 35 extends in parallel with the fourth support member 24. The fifth drive shaft 36 is arranged below the fifth support member 25. The fifth drive shaft 36 extends in parallel with the fifth support member 25. The sixth drive shaft 37 is arranged below the sixth support member 26. The sixth drive shaft 37 extends in parallel with the sixth support member 26.

For example, a plurality of cams 38 are arranged at each of the first through sixth drive shafts 32 through 37. The cams of each of the drive shafts 32 through 37 contact the corresponding one of the first through sixth support members 21 through 26.

As shown in FIG. 1, the drive section 39 is arranged for example outside the cabinet 31. The first through sixth drive shafts 32 through 37 are lined to the drive section 39. The first through sixth drive shafts 32 through 37 are driven by the drive section 39 to rotate around the respective axes of the drive shafts. The rotary motions of the drive shafts are controlled by a control section (not shown). Alternatively, the control section may be contained in the drive section 39.

As the first through sixth drive shafts 32 through 37 rotate as described above, the cams 38 rotate accordingly. As the cams 38 rotate, the sites where the cams 38 contact the first through sixth support members 21 through 26 are shifted. Then, as a result, the first through sixth support members 21 through 26 are driven to move up and down.

The position of the object 7 is defined by the pair of guide members 28 as the paired guide members 28 pinch the object 7 between them. As shown in FIGS. 1 and 2, the guide members 28 are arranged at the opposite sides of the cabinet 31. Note that, in FIG. 1, the guide members 28 are indicated by doubly dotted chain lines. Each of the guide members 28 has a linear profile that for example extends in parallel with the first through sixth support members 21 through 26. Each of the paired guide members 28 can move in a direction that brings it close to the other guide member 28 and in a direction that brings it away from the other guide member 28. In other words, the pair of guide members 28 can adapt itself to the size of the object 7. The guide members 28 operate as a guide section described in the appended claims.

The processing mechanism 40 is arranged above the holding mechanism 20. The processing mechanism 40 is disposed as a fixed position. In other words, it is not driven to move in the X-Y directions. The processing mechanism 40 applies a laser beam onto the object 7 that is held by the holding mechanism 20 to locally heat the object 7 and then locally cool it by supplying a cooling medium 46 such as water in order to break the object 7.

The processing mechanism 40 includes a laser oscillator 41, a reflector mirror 42, a polygon mirror 43 and a cooling nozzle 44. The laser oscillator 41 applies a laser beam 41a. The reflector mirror 42 reflects the laser beam 41a. The polygon mirror 43 reflects the laser beam 41a that is reflected by the reflector mirror 42. As the polygon mirror 43 is driven to rotate, the laser beam 41a reflected by the polygon mirror 43 scans the object 7 from above. As shown in FIG. 2, the laser beam 41a scans an irradiation area 45 defined on the object 7.

As pointed out above, the laser oscillator 41 is not driven to move in the X-Y directions. Therefore, as the holding mechanism 20 is driven to move in the X-Y directions, the position of the irradiation area 45 defined on the object 7 is shifted.

The cooling nozzle 44 blows the cooling medium 46 toward the object 7. Examples of cooling mediums include water, mist (a mixture of water and gas), gases such as nitrogen gas, solids of micro-particles such as carbon dioxide particles, gasified alcohol and alcohol mist.

The posture of the cooling nozzle 44 is adjusted in such a way that the cooling medium 46 can be blown to the site heated by the laser beam 41a on the object 7. Since the cooling nozzle 44 is not driven to move in the X-Y directions, when, the holding mechanism 20 shifts, the position of the area 47 defined on the object 7 where the cooling medium 46 is blown is shifted.

Now, a technique of splitting the object 7 by mean of the apparatus 10 will be described below as an example. Firstly, the object 7 is set in position on the holding mechanism 20. More specifically, the object 7 is mounted on the first through sixth support members 21 through 26 in such a way that an expected splitting line 7a of the object 7 runs in parallel with the first through sixth support members 21 through 26. Thus, the first through sixth support members 21 through 26 contact the lower surface 7d of the object 7.

Note that the expected splitting line 7a is indicated by doubly dotted chain lines and located substantially at the center of the object 7. The expected splitting line 7a is located at the middle point between the third support member 23 and the fourth support member 24. The first through sixth support members 21 through 27 has a length enough for supporting the entire area of the lower surface 7d of the object 7. The first through sixth support members 21 through 27 operate as a support section described in the appended claims.

Then, referring to FIG. 3, the first through sixth drive shafts 32 through 37 are driven to rotate by driving the drive section 39 and the rotary angles of the first through sixth drive shafts 32 through 37 are adjusted by the control section.

The postures of the first through sixth drive shafts 32 through 37 are so selected that the expected splitting line 7a projects most upwardly. More specifically, as shown in FIG. 3, the rotary angles of the first and sixth drive shafts 32, 37 are so adjusted that the cams 38 fitted to them respectively contact the first and sixth support members 21, 26 at the corresponding ends of a minor axes 38a thereof.

The rotary angles of the third and fourth drive shafts 34, 35 are so adjusted that the cams 38 fitted to them respectively contact the third and fourth support members 23, 24 at the front ends of major axes 38b thereof. The rotary angles of the second and fifth drive shafts 33, 36 are so adjusted that the front ends of the major axes 38b thereof are located substantially at the median level between the level of the front ends of the major axes 38b of the third and fourth drive shafts 34, 35 and that of the corresponding ends of the minor axes 38a of the first and sixth drive shafts 32, 37.

As the rotary angles of the first through sixth drive shafts 32 through 37 are adjusted in a manner as described above, the front ends of the first through sixth support members 21 through 26 are arranged to define a curve and the front ends of the third and fourth support members 23, 24 are protruded most upwardly.

With the above-described arrangement, the object 7 arranged at the front ends of the first through sixth support members 21 through 26 is also curved and the curve of the object 7 agrees with the curve defined by the front ends of the first through sixth support members 21 through 26. As pointed out above, the expected splitting line 7a is located at the median position of the third and fourth support members 23, 24. In other words, the expected splitting line 7a is projected most upwardly. As the object 7 is curved, the object 7 is constantly subjected to tensile stress along the expected splitting line 7a due to its own weight. Then, the internal stress produced in the object 7 is offset by the tensile stress.

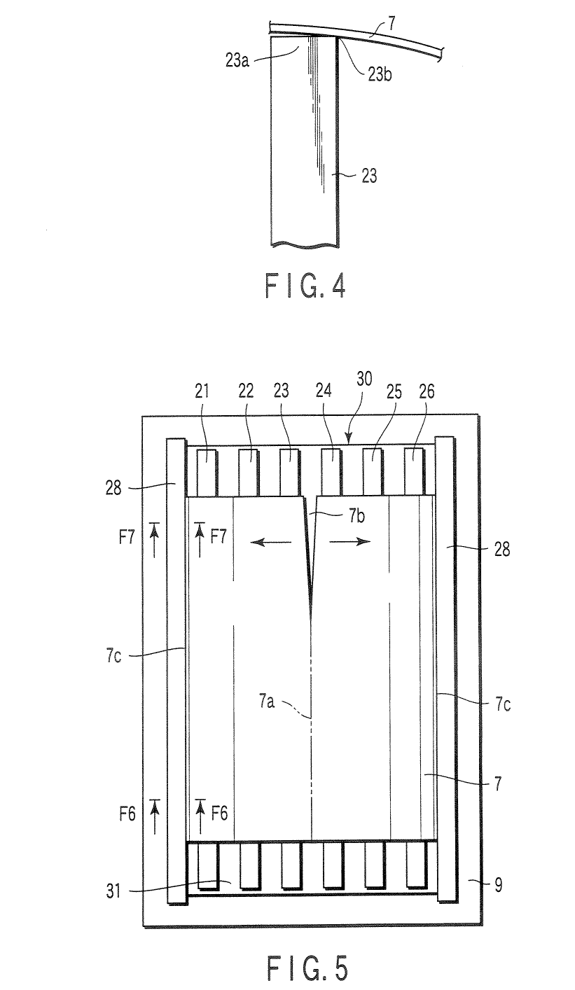

FIG. 4 is a schematic lateral view of the area indicated by F4 shown in FIG. 3. FIG. 4 shows how the front end of the third support member 23 and the object 7 contact with each other. As pointed out above, the first through sixth support members 21 through 26 show a rectangular cross section. Thus, as the object 7 is curved, the third support member 23 contacts the object 7 at the peripheral edge 23b of the front end 23a thereof as shown in FIG. 4. So do the remaining support members including the first, second, fourth, fifth and sixth support members 21, 22, 24, 25, 26. In other words, they contact the object 7 respectively at the peripheral edges 21b through 26b of the front ends 21a through 26a thereof.

Differently stated, as the object 7 is curved, the first through sixth support members 21 through 26 contacts the object 7 along lines. Therefore, the friction between the object 7 and the first through sixth support members 21 through 26 is minimized.

Then, as the guide members 28 are displaced, the object 7 is pinched between the two guide members 28. Thus, the curved posture of the object 7 is held by the holding mechanism 20.

Subsequently, the laser oscillator 41 is operated to apply the object 7 with a laser beam 41a and a cooling medium 46 is blown onto the object 7 by means of the cooling nozzle 44. At the same time, the holding mechanism 20 is displaced in the X direction. As a result, the irradiation area 45 of the laser beam 41a and the area 47 where the cooling medium 46 is blown on the object 7 are shifted so that the fissure 7b develops as shown in FIG. 5. Since the object 7 is subjected to tensile stress along the expected splitting line 7a, the object 7 is broken reliably along the expected splitting line 7a. FIG. 5 is a plan view of the object 7 that is being broken as viewed from above. Note that the processing mechanism 40 is omitted from FIG. 5.

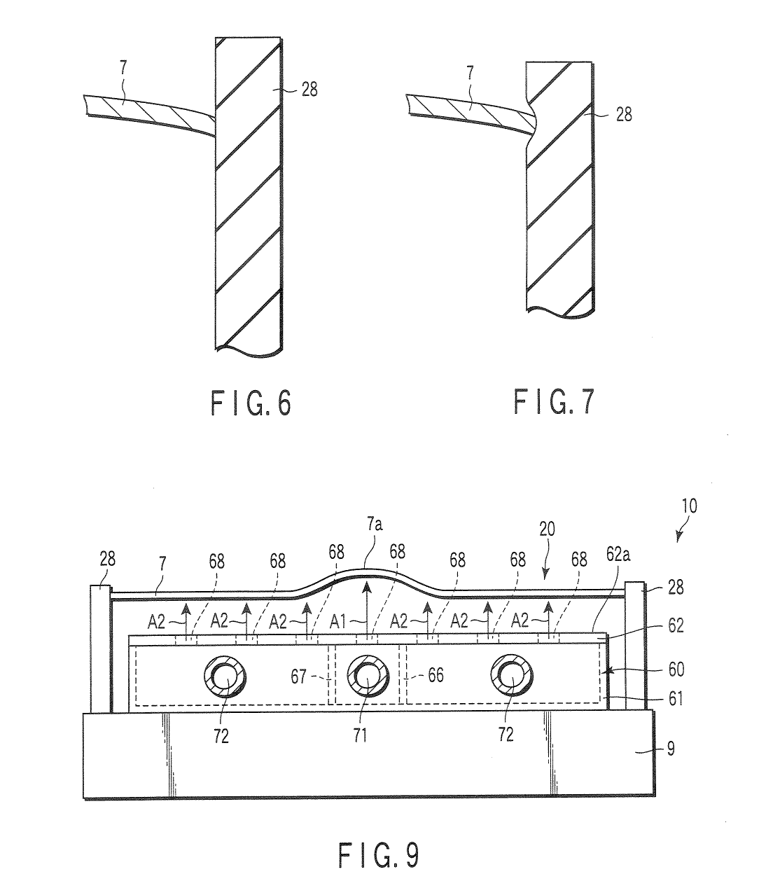

FIG. 6 is a schematic cross sectional view taken along line F6-F6 shown in FIG. 5. FIG. 6 shows how the object 7 contacts the corresponding guide member 28 at the peripheral edge thereof in an area where the fissure 7b is not developing. As seen from FIG. 6, the part of the guide member 28 that contacts the object 7 is not deformed. If it is deformed, it is deformed only slightly.

FIG. 7 is a schematic cross sectional view taken along line F7-F7 shown in FIG. 5. FIG. 7 shows how the object 7 contacts the corresponding guide member 28 at the peripheral edge thereof in an area where the fissure 7b is developing. As seen from FIG. 7, as the fissure 7b is produced in the object 7, the opposite sides of the object 7 relative to the fissure 7b are displaced and moved away from each other along the fissure 7b.

As shown in FIG. 7, the guide member 28 is deformed so as not to obstruct the displacement of the object 7 that is made due to the fissure 7b. In other words, the guide member 28 is so formed as to absorb a minute displacement of the object 7.

With an apparatus 10 having the above-described configuration, the object 7 is constantly subjected to tensile stress along the expected splitting line 7a as the object 7 is curbed by the holding mechanism 20 so as to project the expected splitting line 7a upwardly. Then, the internal stress originally produced in the object 7 is cancelled by the tensile stress so that it is possible to minimize the influence of the compression stress at the surface of and the internal stress of the object 7 that is exerted on the splitting process.

Then, the accuracy of the splitting process of the object 7 is improved. Additionally, the force for splitting the object 7 is increased when the thermal stress due to the irradiation of laser beam and the tensile stress are utilized so that the object 7 can be fully cut apart.

Additionally, since the holding mechanism 20 has a simple structure of comprising the first through sixth support members 21 through 26, the cost of the apparatus 10 can be relatively held low.

The holding mechanism 20 comprises the height adjusting mechanism 30 for adjusting the heights of the first through sixth support members 21 through 26 in addition to the first through sixth support members 21 through 26. The object 7 is mildly curved by the height adjusting mechanism 30. As the object 7 is curved, the substantially entire area of the object 7 is subjected to tensile stress. In other words, the accuracy of the splitting process is improved regardless of the position of the expected splitting line 7a on the object 7.

Still additionally, the first through sixth support members 21 through 26 show a rectangular cross section so that they contact the object 7 only along lines. Therefore, the friction between the object 7 and the first through sixth support members 21 through 26 is minimized. Thus, the accuracy of the splitting process is further improved, since interference of the displacement of the object 7 can be prevented due to the friction between the first through sixth support members 21 through 26 and the object 7.

Finally, the guide members 28 are deformed so as not to obstruct the displacement of the object 7. Thus, the displacement of the object 7 is hardly obstructed so that the accuracy of the splitting process is further improved.

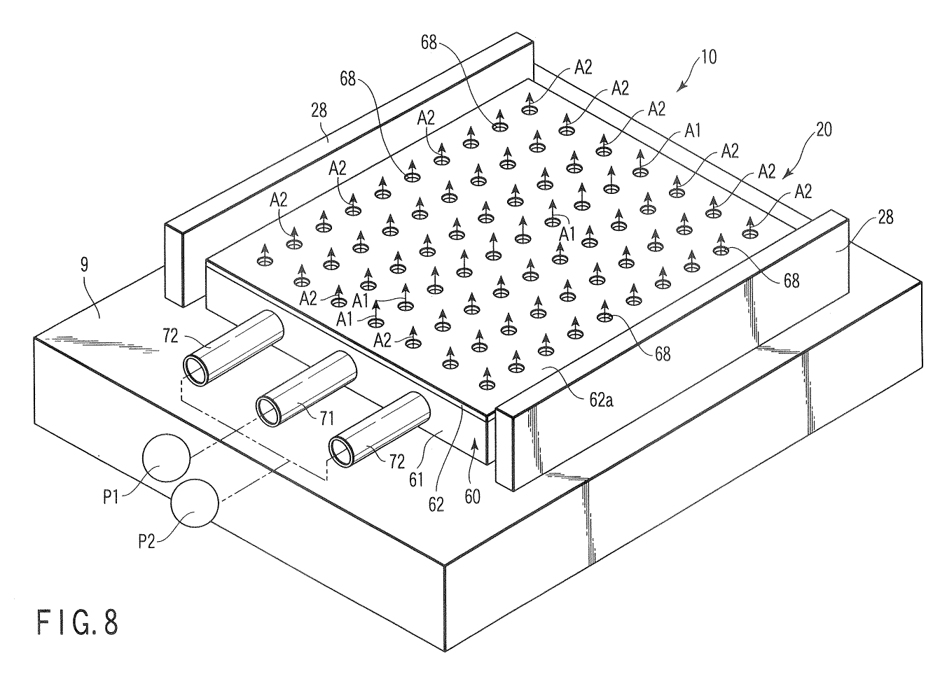

Now, an apparatus according to the second embodiment of the present invention will be described by referring to FIGS. 8 through 10. The components same as or similar to those of the first embodiment are denoted respectively by the same reference symbols and will not be described any further. This embodiment differs from the first embodiment in terms of the structure of the holding mechanism 20. Otherwise, this embodiment may be identical with the first embodiment. Therefore, only the difference will be specifically described below.

FIG. 8 is a schematic perspective view of the apparatus 10 of this embodiment. The processing mechanism 40 is omitted from FIG. 8. As shown in FIG. 8, the holding mechanism 20 includes a pair of guide members 28 and an air float apparatus 60.

FIG. 9 is a schematic lateral view of the apparatus 10 as viewed in the direction along which the first through sixth support members 21 through 26 extend. As shown in FIG. 9, the air float apparatus 60 is disposed oppositely relative to the object 7. The air float apparatus 6 causes the object 7 to float by blowing air to the object 7 from below.

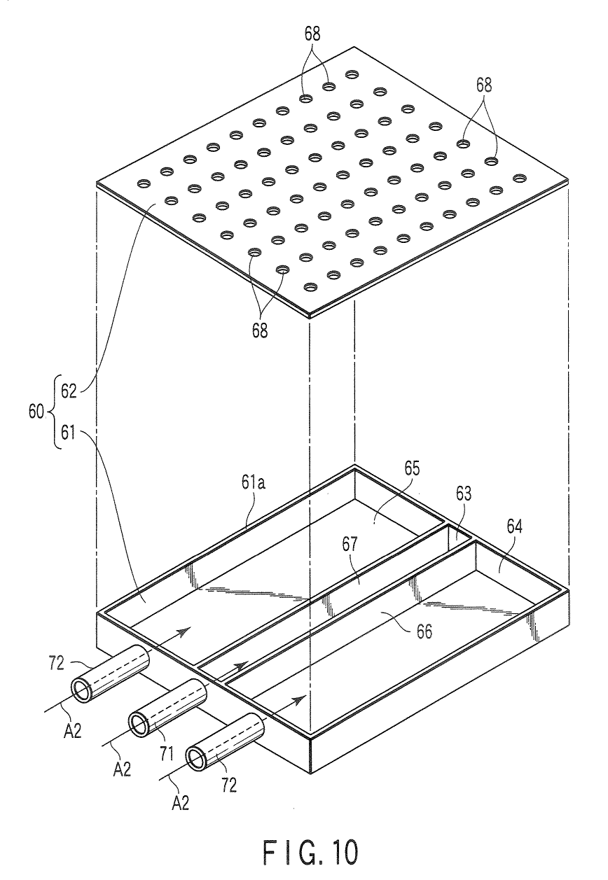

FIG. 10 is an exploded schematic perspective view of the air float apparatus 60. As shown in FIG. 10, the air float apparatus 60 includes a main body 61 and a closure member 62. The main body 61 is box-shaped and open at the top. First through third containing sections 63 through 65 are formed in the main body 61.

The first containing section 63 is arranged in the air float apparatus 60 at a position opposite to the expected splitting line 7a. The first containing section 63 is defined by first and second beams 66, 67 and the related internal surfaces of the main body 61. The first and second beams 66, 67 are separated from each other and arranged in the main body 61 so as to extend along the expected splitting line 7a.

The second containing section 64 is defined by the first beam 66 and the related internal surfaces of the main body 61. The third containing section 65 is defined by the second beam 67 and the related internal surfaces of the main body 61.

The closure member 62 airtight covers the top opening 61a of the main body 61. The first through third containing sections 63 through 65 become airtight relative to each other as the first and second beams 66, 67 contact the closure member 62.

As shown in FIG. 9, as the object 7 is arranged on the holding mechanism 20, the closure member 62 is disposed opposite to the object 7. A plurality of spouting holes 68 are formed through the closure member 62. The spouting holes 68 are uniformly distributed. The spouting holes 68 have a uniform size.

As shown in FIG. 10, a first supply pipe 71 for supplying first air A1 to the first containing section 63 is connected to the main body 61. As shown in FIG. 8, the first supply pipe 71 is connected to a first pump P1. Second supply pipes 72 for supplying second air A2 to the second and third containing sections 64, 65 are connected to the main body 61. The second supply pips 72 are connected to a second pump P2.

The first air A1 contained in the first containing section 63 is spouted out toward the object 7 by way of the spouting holes 68 formed through the closure member 62 in the area opposed to the first containing section 63. The second air A2 contained in the second and third containing sections 64, 65 is spouted out toward the object 7 by way of the spouting holes 68 formed through the closure member 62 in the areas opposed respectively to the second and third containing sections 64, 65. The object 7 is floated relative to the upper surface 62a of the closure member 62 as the first and second airs A1, A2 are blown against it. The upper surface 62a has an area larger than that of the object 7. In other words, the upper surface 62a opposes the entire lower surface of the object 7.

The spouting pressure of the first air Al pouted by the first pump P1 is defined to be higher than the spouting pressure of the second air A2 spouted by the second pump P2 so that the expected splitting line 7a is projected most upwardly.

With the apparatus 10 of this embodiment, the object 7 is caused to float relative to an upper surface 62a of the closure member 62 by means of the air float apparatus 60 so that there arises no friction that can obstruct the displacement of the object 7 when the object 7 is broken. Thus, this embodiment further improves the accuracy of the splitting process in addition to the first embodiment.

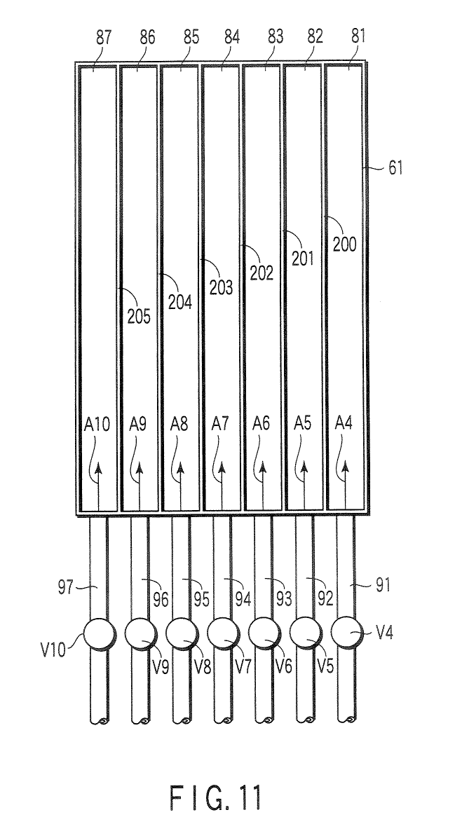

Now, an apparatus according to the third embodiment of the present invention will be described by referring to FIG. 11. The components same as or similar to those of the second embodiment are denoted respectively by the same reference symbols and will not be described any further.

This embodiment differs from the second embodiment in terms of the structure of the air float apparatus 60. Otherwise, this embodiment may be identical with the second embodiment. Therefore, only the difference will be specifically described below.

FIG. 11 is a schematic plan view of the main body 61 of this embodiment. As shown in FIG. 11, fourth through tenth containing sections 81 through 87 are additionally formed in the main body 61. More specifically, third through eighth beams 200 through 205 are formed in the main body 61.

The third through eighth beams 200 through 205 are separated from each other and arranged along the expected splitting line 7a. The third through eighth beams 200 through 205 are linked to the main body 61 at the opposite ends thereof as viewed in the direction along which the expected splitting line 7a extends to form the fourth through tenth containing sections 81 through 87 in the main body 61. As the closure member 62 is fitted to the main body 61, the third through eighth beams 200 through 205 abut the lower surface of the closure member 62. Thus, as the closure member 62 is fitted to the main body 61, the fourth through tenth containing sections 81 through 87 are airtight separated from each other.

Fourth through tenth supply pipes 91 through 97 are connected respectively to the fourth through tenth containing sections 81 through 87. Fourth through tenth airs A4 through A10 are supplied independently to the respective fourth through tenth supply pipes 91 through 97. Fourth through tenth valves V4 through V10 are provided respectively to the fourth through tenth supply pipes 91 through 97. The fourth through tenth valves V4 through V10 respectively adjust the spouting pressures of the fourth through tenth airs A4 through A10.

With this embodiment, by adjusting the fourth through tenth valves V4 through V10, it is possible to adjust the pressures of the fourth through tenth airs A4 through A10 supplied respectively to the fourth through tenth containing sections 81 through 87. Therefore, for example, if the expected splitting line 7a is located above the fourth containing section 81, the pressure of the fourth air A4 supplied to the fourth containing section 81 is raised by adjusting the fourth valve V4. Then, as a result, the expected splitting line 7a is projected most upwardly.

If the position of the expected splitting line 7a is shifted, it is possible to curve the object 7 so as to project the expected splitting line 7a most upwardly by adjusting the pressure of the air supplied to the containing section located opposite to the expected splitting line 7a out of the fourth through tenth containing sections 81 through 87.

Thus, this embodiment provides advantages similar to those of the first and second embodiments. While the fourth through tenth containing sections 81 through 87 are provided in this embodiment, the number of containing sections is not limited.

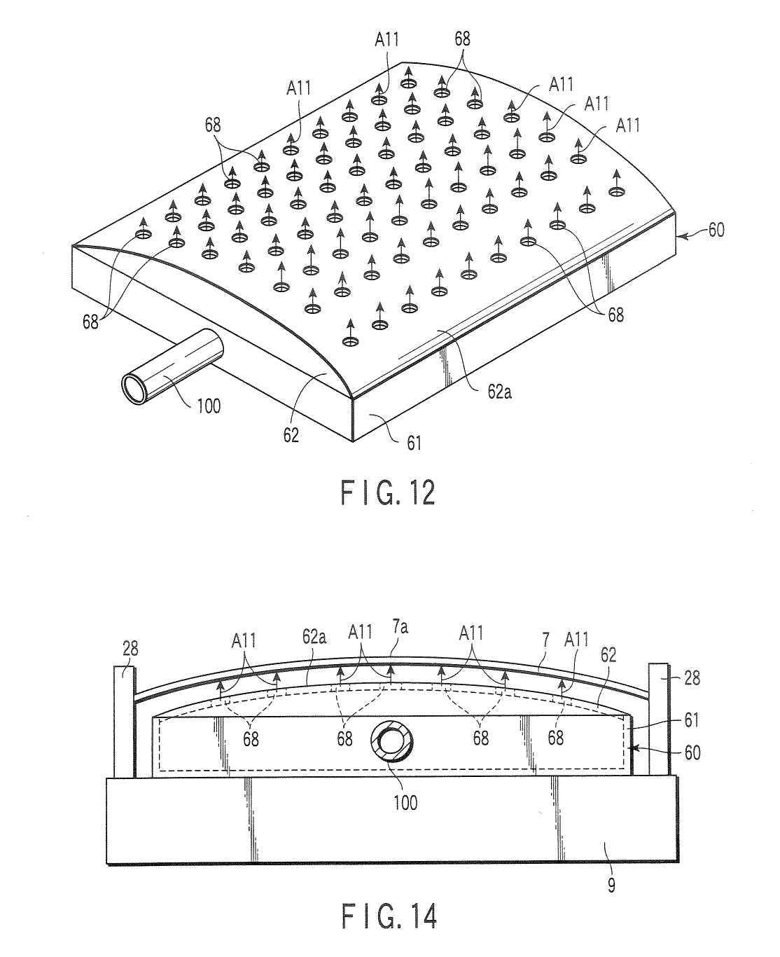

Now, an apparatus according to the fourth embodiment of the present invention will be described by referring to FIGS. 12 through 14. The components same as or similar to those of the second embodiment are denoted respectively by the same reference symbols and will not be described any further. This embodiment differs from the second embodiment in terms of the structure of the air float apparatus 60. Otherwise, this embodiment may be identical with the second embodiment. Therefore, only the difference will be specifically described.

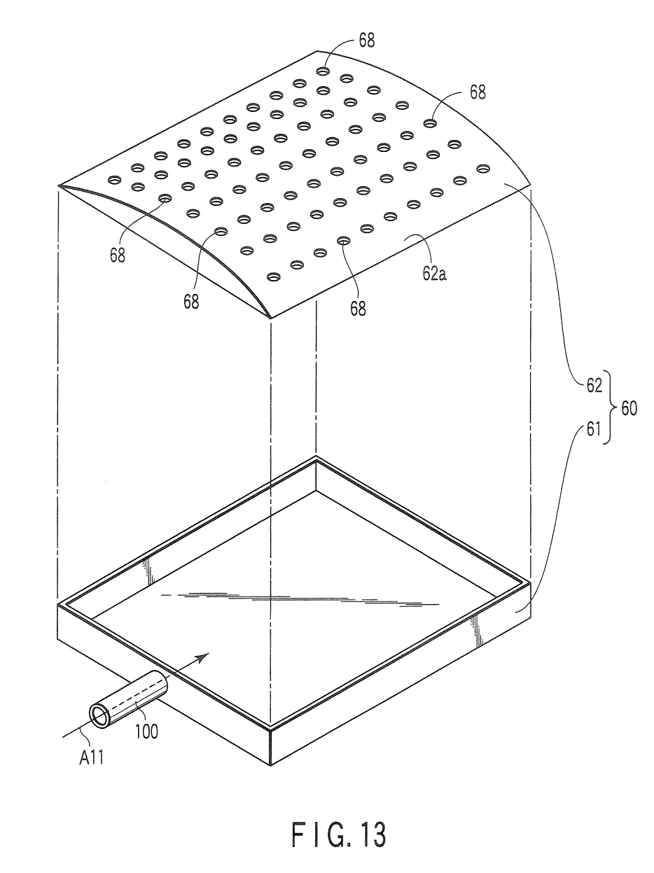

FIG. 12 is a schematic perspective view of the air float apparatus 60 of this embodiment. FIG. 13 is an exploded schematic perspective view of the air float apparatus 60. FIG. 14 is a schematic lateral view of the apparatus 10 as viewed in the direction along which the first through sixth support members 21 through 26 extend.

As shown in FIGS. 12 and 13, the upper surface 62a of the closure member 62 is curved. The upper surface 62a faces the object 7. Only a single containing section is formed in the main body 61 to contain air A11.

As the upper surface 62a is curved in this embodiment, the object 7 is curved to conform to the profile of the upper surface 62a if the air A11 is spouted out from the spouting holes 68 with a uniform spouting pressure. Thus, this embodiment requires neither a plurality of pumps nor a plurality of containing sections. Therefore, this embodiment provides an advantage of a simple structure of the apparatus 10 in addition to the advantages of the second embodiment.

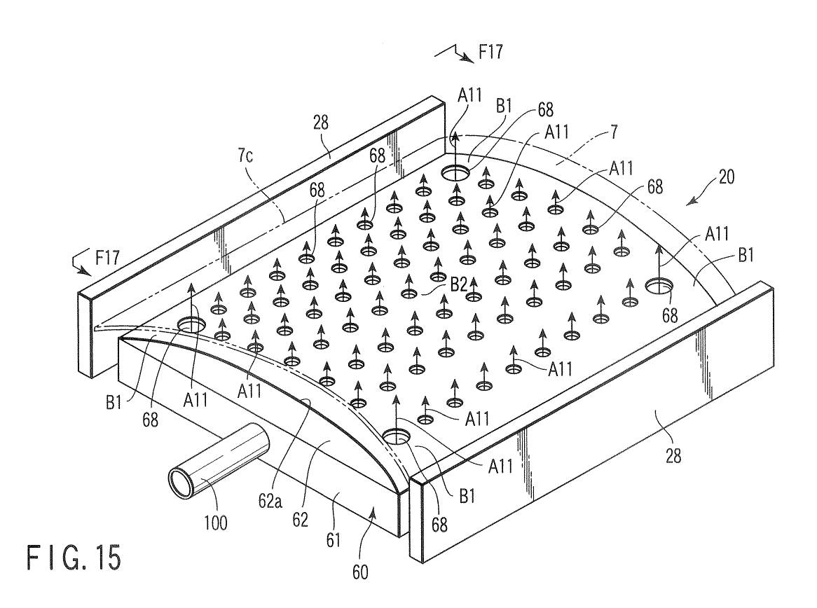

Now, an apparatus according to the fifth embodiment of the present invention will be described by referring to FIGS. 15 through 17. The components same as or similar to those of the third embodiment are denoted respectively by the same reference symbols and will not be described any further. This embodiment differs from the third embodiment in terms of the profile of the spouting holes 68. Otherwise, this embodiment may be identical with the third embodiment. Therefore, only the difference will be specifically described below.

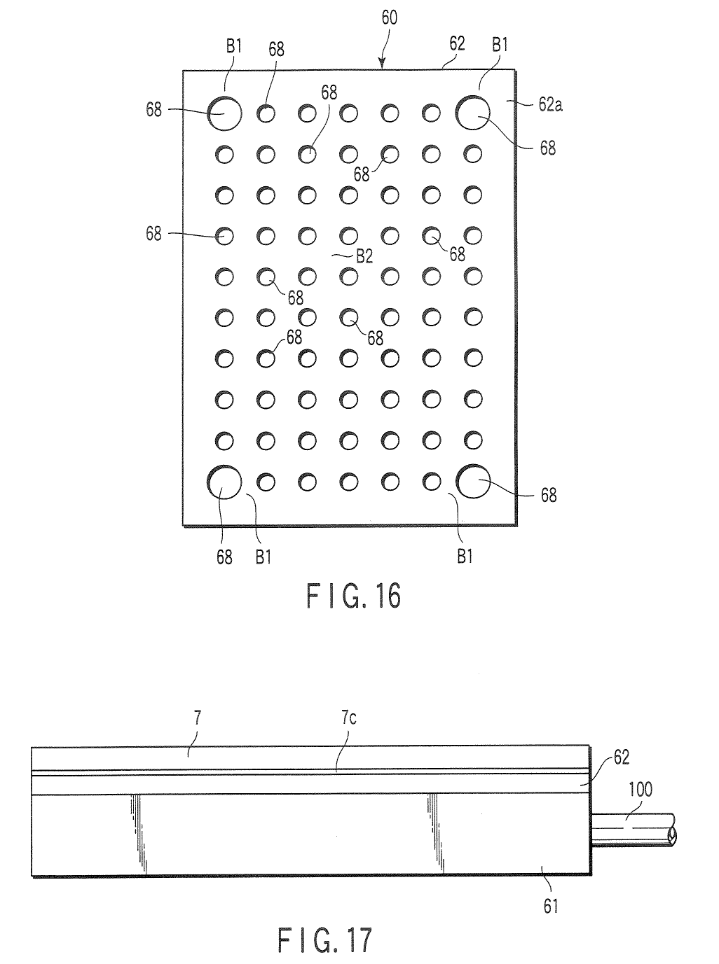

FIG. 15 is a schematic perspective view of the holding mechanism 20 of this embodiment. In FIG. 15, the object 7 is indicated by doubly dotted chain line. FIG. 16 is a schematic plan view of the air float apparatus 60. As shown in FIGS. 15 and 16, the areas of the upper surface 62a of the closure member 62 disposed opposite to the four corners of the object 7 are collectively referred to as first area B1. The area of the upper surface 62a other than the first area B1 is referred to as second area B2.

All the spouting holes 68 formed in the second area B2 have a same size. The spouting holes 68 formed in the first area B1 have a size larger than that of the spouting holes 68 formed in the second area B2. Therefore, the object 7 is pushed upward by the air A11 more strongly at the four corners than in the area other than the four corners.

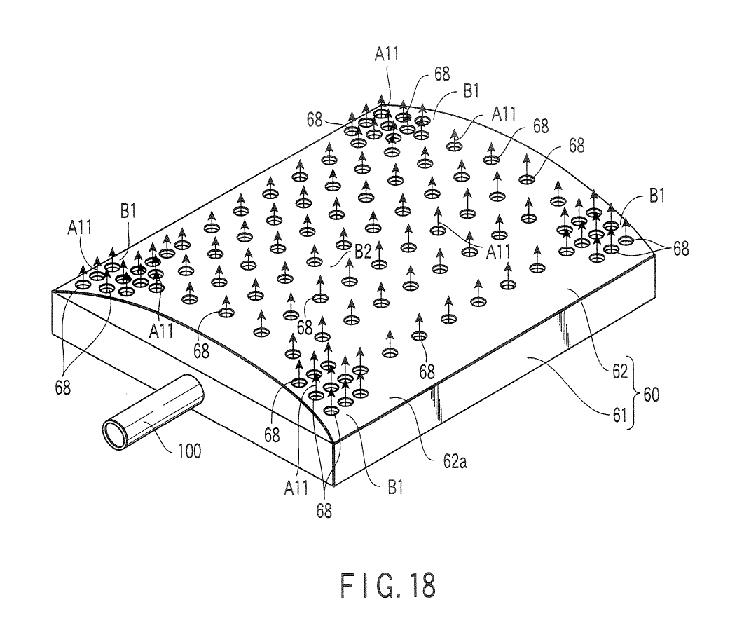

The size of the spouting holes 68 formed in the first area B1 will be specifically described below. FIG. 17 is a schematic cross sectional view taken along line F17-F17 shown in FIG. 15. FIG. 17 shows a view of the peripheral edge 7c of the object 7 that contacts the corresponding guide member 28 as viewed from the side of the guide members 28.

The object 7 can hang down at the four corners so as to be located below the remaining part thereof due to the own weight particularly when the object 7 is large. The size of the spouting holes 68 formed in the first area B1 is so defined as to give rise to force sufficient for pushing up the four corners of the object 7 and preventing them from hanging down. Therefore, as shown in FIG. 17, the peripheral edge 7c of the object 7 is held so as to show a substantially linear profile.

Thus, with this embodiment, the posture of the object 7 is more stabilized to improve the accuracy the process of splitting the object 7.

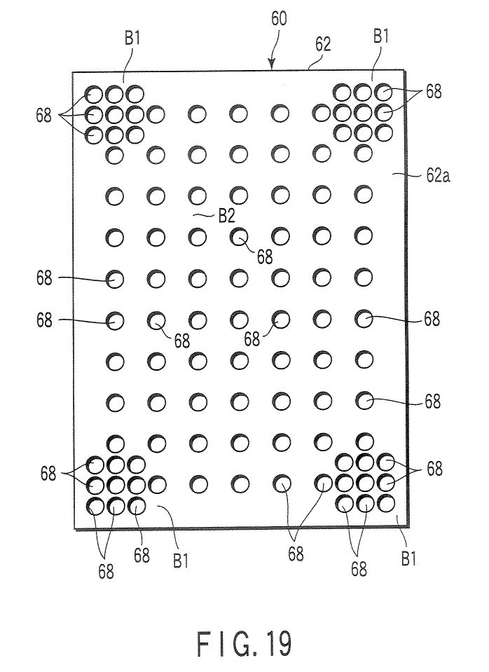

Now, an apparatus according to the sixth embodiment of the present invention will be described by referring to FIGS. 18 and 19. The components same as or similar to those of the fifth embodiment are denoted respectively by the same reference symbols and will not be described any further. This embodiment differs from the fifth embodiment in terms of density and the size of the spouting holes 68 formed in the first area B1. Otherwise, this embodiment may be identical with the fifth embodiment. Therefore, only the difference will be specifically described below.

FIG. 18 is a schematic perspective view of the air float apparatus 60 of this embodiment. FIG. 19 is a schematic plan view of the air float apparatus 60. As shown in FIGS. 18 and 19, the spouting holes 68 formed in the first area B1 are the same as those formed in the second area B2 in terms of size and profile. However, spouting holes 68 are formed more densely in the area B1 than in the area B2. This embodiment provides advantages same as those of the fifth embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for splitting an object by locally heating and cooling the object and making a fissure in the object by thermal stress, said apparatus comprising:
a holding mechanism which holds the object in a curved state so as to project the expected splitting line thereof; and
a processing mechanism which applies a laser beam to the object held by the holding mechanism, to heat the object locally.

2. The apparatus according to claim 1, wherein
the holding mechanism includes a plurality of support sections arranged substantially in parallel with each other substantially at regular intervals, adjusts the height of the support sections and holds the object so as to project the expected splitting line.

3. The apparatus according to claim 1, wherein
the holding mechanism includes an gas float mechanism having an opposite surface to be arranged opposite to the object and adapted to hold the object in a floating state with respect to the opposite surface by spouting gas toward the object; and
the spouting pressure of gas in the vicinity of the expected splitting line of the object being higher than the spouting pressure at sites other than in the vicinity of the expected splitting line of the object so as to project the expected splitting line most.

4. The apparatus according to claim 1, wherein
the holding mechanism includes an gas float mechanism having an opposite surface to be arranged opposite to the object and adapted to hold the object in a floating state with respect to the opposite surface by spouting gas toward the object;
the gas float mechanism has a containing section for containing the gas before being spouted;
a plurality of spouting holes to be passed by the gas contained in the containing section are formed through the opposite surface; and
the opposite surface are curved so as to project at the site thereof located opposite to the expected splitting line.

5. The apparatus according to claim 4, wherein
the opposite surface has a first region and a second region, the first region being located opposite the corner sections of the object; and
the spouting holes formed in the first region are larger than the spouting holes formed in the second region.

6. The apparatus according to claim 4, wherein
the opposite surface has a first region and a second region, the first region being located opposite to the corner sections of the object; and
the spouting holes are formed more densely in the first region than in the second region.

7. The apparatus according to claim 1, wherein
the holding mechanism includes:
a gas float mechanism which has an opposite surface to be arranged opposite to the object and holds the object in a floating state with respect to the opposite surface by spouting gas toward the object; and
the gas float mechanism includes:
a plurality of containing sections which extend along the expected splitting line, are arranged in a direction intersecting the expected splitting line and contain the gas before being spouted;
a plurality of spouting holes to be passed by the gas contained in the containing sections are formed through the opposite surface; and
passage sections which leads the gas into the respective containing sections are provided with respective valves for adjusting the gas spouting pressure.

8. The apparatus according to claim 1, wherein
the holding mechanism includes a guide section for supporting the object by pinching the object from the opposite sides thereof with the expected splitting line interposed between them and
the guide section is deformed to absorb the displacement of the object.

9. A method of splitting an object by locally heating and cooling the object and making a fissure in the object by the thermal stress, the method comprising:
deforming the object so as to cause a tensile stress thereof to act on the opposite sides of the object with respect to the expected splitting line of the object operating as center line.

10. The method according to claim 9, wherein
the object is deformed by means of a holding mechanism for holding the object; and
the holding mechanism includes:
support sections which are arranged at least one at each of the opposite sides with the expected splitting line interposed between them, extend along the expected splitting line and adapted to contact the opposite surface of the object to be located opposite to the holding mechanism so as to project the expected splitting line.

11. The method according to claim 10, wherein
a plurality of support sections are formed; and
the holding mechanism has a height adjusting mechanism for adjusting the heights of the plurality of support sections.

12. The method according to claim 9, wherein
the object is held in a floating state by gas spouted from a plurality of gas spouting holes; and
the spouting pressure of gas in the vicinity of the expected splitting line of the object is made higher than the spouting pressure at sites other than in the vicinity of the expected splitting line of the object so as to project the expected splitting line most.

13. The method according to claim 9, wherein
the object is deformed by means of the holding mechanism for holding the object; and
the holding mechanism includes an gas float mechanism having an opposite surface to be arranged opposite to the object and holds the object in a floating state with respect to the opposite surface by spouting gas toward the object;
the gas float mechanism has a containing section for containing the gas before being spouted;
a plurality of spouting holes to be passed by the gas contained in the containing section are formed through the opposite surface; and
the opposite surface is curved so as to project at the site thereof located opposite to the expected splitting line.

14. The method according to claim 13, wherein
the opposite surface has a first region and second region, the first region being located opposite to the corner sections of the object; and
the spouting holes formed in the first region are larger than the spouting holes formed in the second region.

15. The method according to claim 13, wherein
the opposite surface has a first region and a second region, the first region being located opposite to the corner sections of the object; and
the spouting holes are formed more densely in the first region than in the second region.

16. The method according to claim 9, wherein
the object is deformed by means of the holding mechanism for holding the object; and
the holding mechanism includes:
a gas float mechanism which has an opposite surface to be arranged opposite to the object and holds the object in a floating state with respect to the opposite surface by spouting gas toward the object;
the gas float mechanism has a plurality of containing sections which extend along the expected splitting line, are arranged in a direction intersecting the expected splitting line and contain the gas before being spouted;
a plurality of spouting holes to be passed by the gas contained in the containing sections are formed through the opposite surface; and
passage sections for leading the gas into the respective containing sections are provided with respective valves for adjusting the gas spouting pressure.

17. The method according to claim 9, wherein
the object is deformed by means of the holding mechanism; and
the holding mechanism includes a guide section for supporting the object by pinching the object from the opposite sides thereof with the expected splitting line interposed between them; and
the guide section is deformed to absorb the displacement of the object.
